(19) United States
(12) Patent Application Publication
(10) Pub. No.: US 2010/0228364 A1
(43) Pub. Date: Sep. 9, 2010

(54) PLANT INFORMATION MANAGING DEVICE AND PLANT INFORMATION MANAGING METHOD

(75) Inventors: Masayasu Ohashi, Tokyo (JP); Takafumi Inoue, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 12/716,407

(22) Filed: Mar. 3, 2010

(30) Foreign Application Priority Data
Mar. 3, 2009 (JP) 2009-048934

(51) Int. Cl. G05B 11/01

(52) U.S. Cl. 700/17

(57) ABSTRACT

Terminal devices 5 include a definition receiving section 51 for receiving a definition of an imaginary unit as a collection of a data relating to a plant, a suggestion section 52 for suggesting the data belonging to the imaginary unit defined via the definition receiving section 51, a searching section 53 for searching the imaginary unit using a search key provided to the imaginary unit, and a preservation section 56 for preserving the imaginary unit defined via the definition receiving section 51. In addition, a communication portion 57 for communicating via the network 6 is installed in the terminal device 5.

### CROSS-REFERENCE TO RELATED APPLICATION

This application is based on and claims priority under 35 U.S.C. §119 from Japanese Patent Application No. 2009-048934 filed on Mar. 03, 2009.

### BACKGROUND OF THE INVENTION

1. Technical Field

The invention relates to a plant information managing device and a plant information managing method for managing a data group relating to a plant.

2. Related Art

In order to stably and securely operate a plant, persons engaged in the plant grasp conditions of processes based on various information collected from various places and manage the quality and deadlines of a product. Furthermore, not only the stability and security of the plant, but also sufficient operation and continuous improvement in processes are required.

For example, an operator monitors tendencies etc. of trends of a process data which affects the quality of a product, according to production directions. In addition, a production section chief confirms whether a manufacturing amount will meet a production schedule by means of trends, and checks the working state of persons engaged in the production. On the other hand, an operator staff member checks the trends of running states of each process of a production, and a preservation staff member checks trends of the running states of equipments.

### [Patent Document 1] JP-A-2009-009399

However, in a conventional system, analytic tools, which are used in an analysis by each staff member, use independently collected data so that they are not connected with each other. As a result, data collected from various collection sources for achieving a certain object, cannot be used elsewhere.

Furthermore, the collected data is incapable of performing the cut of the data without the use of a time as a key, and a thorough search of a product is difficult. For example, it is difficult to search the data such as the device list used for producing a specific lot for a claimed product. Furthermore, it is also difficult to search the past data by using an identical operation condition as a key.

In addition, even when the data are collected for a particular object, gaining later access to the data is difficult. For this reason, for example, at the time of the occurrence of a trouble or the like, it is difficult to rapidly refer to the past cases.

### SUMMARY OF THE INVENTION

An object of the invention is to provide a plant information managing device and a plant information managing method that can effectively use a data group relating to a plant.

According to a first aspect of the invention, there is provided a plant information managing device for managing a data group relating to a plant, including:

a definition receiving section for receiving a definition of a unit as a collection of data, and

a suggestion section for suggesting the data belonging to a predetermined unit which has been selected among the units defined via the definition receiving section.

According to the plant information managing device, the definition of the unit as the collection of the data is received and accordingly the data belonging to the predetermined unit which has been selected among the defined units is suggested so that a data group relating to the plant can be effectively used.

According to a second aspect of the invention, there is provided the plant information managing device as in the first aspect, further including:

a searching section for searching the unit using the search key provided to the unit, wherein

the suggestion section suggests the data belonging to the unit searched by the searching section.

According to a third aspect of the invention, there is provided the plant information managing device as in the first or second aspect, wherein

the suggestion section suggests the same kind of data belonging to a plurality of the units in a comparable manner.

According to a fourth aspect of the invention, there is provided the plant information managing device as in the third aspect, wherein

the data is a time series data, and

the suggestion section displays the same kind of data in such a manner in which the time axis is arranged.

According to a fifth aspect of the invention, there is provided the plant information managing device as in any one of the first to fourth aspects, further including:

a preservation section for preserving the unit defined via the definition receiving section, wherein

the suggestion section suggests the data belonging to the unit preserved by the preserving section.

According to a sixth aspect of the invention, there is provided the plant information managing device as in any one of the first to fifth aspects, wherein

the unit defines the collection of the data relating to a particular product.

According to a seventh aspect of the invention, there is provided the plant information managing device as in any one of the first to fifth aspects, wherein

the unit defines the collection of the data relating to a particular process.

According to an eighth aspect of the invention, there is provided a plant information managing method of managing a data group relating to a plant, including:

receiving a definition of a unit as a collection of the data, and

suggesting the data belonging to a predetermined unit which has been selected among the units defined via the step of receiving the definition.

According to the plant information managing method, the definition of the unit as the collection of the data is received and accordingly, the data belonging to the predetermined unit which has been selected among the defined units is suggested, so that a data group relating to the plant can be effectively used.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIGS. 1A and 1B are diagrams showing a structure of a field control system to which a plant information managing device is applicable, FIG. 1A is a block diagram showing the structure of the field control system, and FIG. 1B is a block diagram showing a structure of a terminal device;

FIG. 2 is a diagram showing an example of “a product unit” as an imaginary unit;

FIG. 3 is a diagram showing an example of “a process unit” as an imaginary unit;

FIG. 4 is a diagram showing an example of “a raw material unit”, “a utility unit”, and “a person unit” as imaginary units;

FIG. 5 is a diagram showing an example of “a device unit” as an imaginary unit;

FIGS. 6A and 6B are diagrams showing an example of a corresponding relationship between each time series data stored in an imaginary unit and display configurations of each data, FIG. 6A is a diagram showing a corresponding relationship in a unit which stores the time series data group relating to a product, and FIG. 6B is a diagram showing a corresponding relationship in a unit which stores a time series data group relating to a utility;

FIG. 7 is a diagram that shows an example of a corresponding relationship between each time series data stored in an imaginary unit and display configurations of each data and shows a corresponding relationship in a unit that stores a time series data group relating to a raw material to be input;

FIGS. 8A and 8B are diagrams showing an example of a corresponding relationship between each time series data stored in an imaginary unit and display configurations of each data, FIG. 8A is a diagram showing a corresponding relationship in a unit that stores the time series data group relating to a person, and FIG. 8B is a diagram showing a corresponding relationship in a unit that stores the time series data group relating to a device (reactor);

FIG. 9 is a diagram showing an analysis screen when a trouble arises in a product;

FIG. 10 is a diagram showing an analysis screen of a batch process;

FIG. 11 is a diagram showing a display screen which shows detailed information of a device;

FIG. 12 is a diagram showing a display screen of report information of a trouble;

FIGS. 13A and 13B are diagrams showing a writing method or the like of a past case, FIG. 13A is a diagram showing an example of an event (time series data) constituting the past case of a response to an alarm, and

FIG. 13b is a diagram showing field data (time series data) contained in a device unit (resistor unit);

FIG. 14 is a diagram showing a graphical display example of the written past case;

FIGS. 15A and 15B are diagrams showing a display screen, FIG. 15A is a diagram that shows an example in which timings of events in a plurality of the past cases are graphically displayed, and FIG. 15B is a diagram that shows a display screen example which displays the number distributions of operation contents subsequently adopted; and

FIG. 16 is a diagram showing an example in which a restriction condition is divided into two step layers.

### DETAILED DESCRIPTION OF THE PREFERRED EMBODIMENTS

Hereinafter, an embodiment of a plant information managing device according to the invention is described.

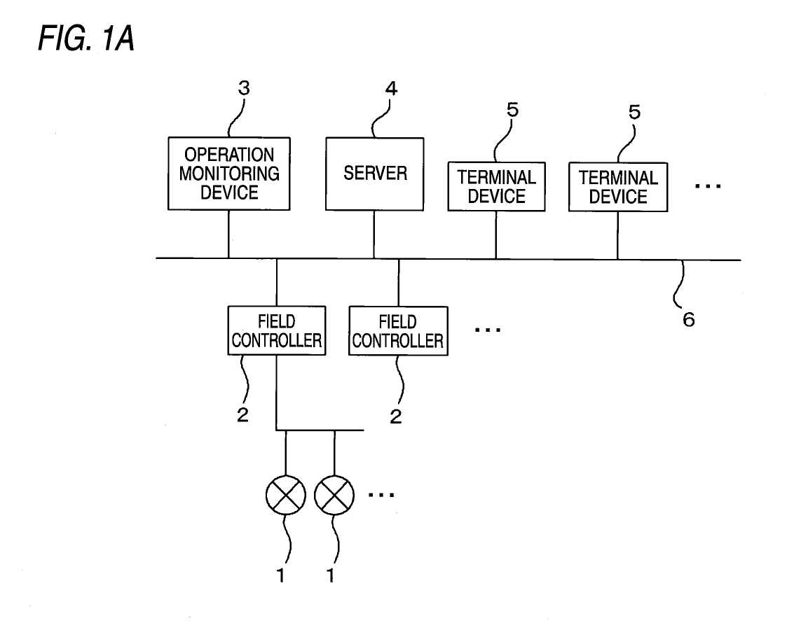

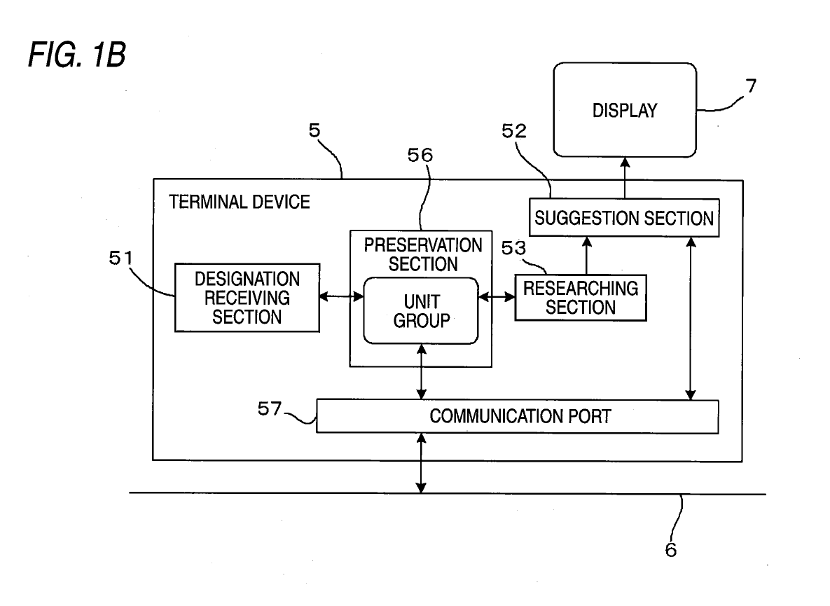

FIGS. 1A and 1B are block diagrams that show structures of field control systems to which a plant information managing device of the invention is applicable.

As shown in FIG. 1A, the field control system includes field controllers 2, which are dividedly arranged in the plant, an operation monitoring device 3 for operational monitoring field equipments 1 via the field controllers 2, a server 4 for storing data such as field data (historical data) and other data relating to the plant, and terminal devices 5 for performing accesses to various data relating to the plant. The field controllers 2, the operation monitoring device 3, the server 4 and the terminal devices 5 are connected each other via a network 6.

As shown in FIG. 1B, the terminal devices 5 include a definition receiving section 51 for receiving a definition of an imaginary unit as a collection of a data relating to a plant, a suggestion section 52 for suggesting the data belonging to the imaginary data defined via the definition receiving section 51, a searching section 53 for searching the imaginary unit using a search key provided to the imaginary unit, and a preservation section 56 for preserving the imaginary unit defined via the definition receiving section 51. Furthermore, a communication portion 57 for communicating via the network 6 is installed in the terminal device 5. In addition, the preservation section may not be installed in the terminal device 5. For example, it may be installed as a function of the server 4 or as other memory devices connected to the network 6.

Basic structures of the imaginary unit include “a name”, “a data main body”, and “a property (attribute)”. In the “data main body”, current data/historical data, a current message/a historical message, a method, and a file and the like are included.

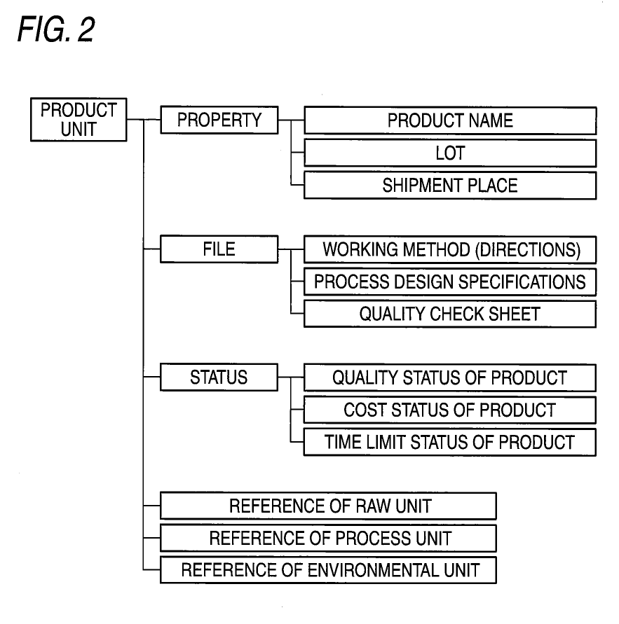

FIGS. 2 to 6 are diagrams that exemplify the structures of the imaginary unit. The imaginary unit is a bundle of data relating to a plant, and the contents of the imaginary unit can be freely set via the definition receiving section 51 by a user. The data stored in the imaginary unit can designate any data irrespective of whether such is logical data/physical data.

In addition, in the “data” stored in the imaginary unit, information specifying the data or a meaning (for example, “a value of present field data”) of the data is included, and “a data value” or “an image” does not need to be stored. At the time of suggestion by the suggestion section 52, the field data and the historical data, and other data values and images can be properly obtained via the network 6.

FIG. 2 shows an example of “a product unit” as an imaginary unit. The product unit monitors the product produced in the plant, and is a collection of the information that collates the data related in each step from raw materials to products. In the example shown in FIG. 2, the data relating to the products are classified and stored into “a property” showing an attribute of a product, “a file” showing an image file relating to a product, and “a status” showing a state relating to a product. In addition, as a unit that is referable by a development from a display screen, a raw material unit, a process unit and an environment unit are designated.

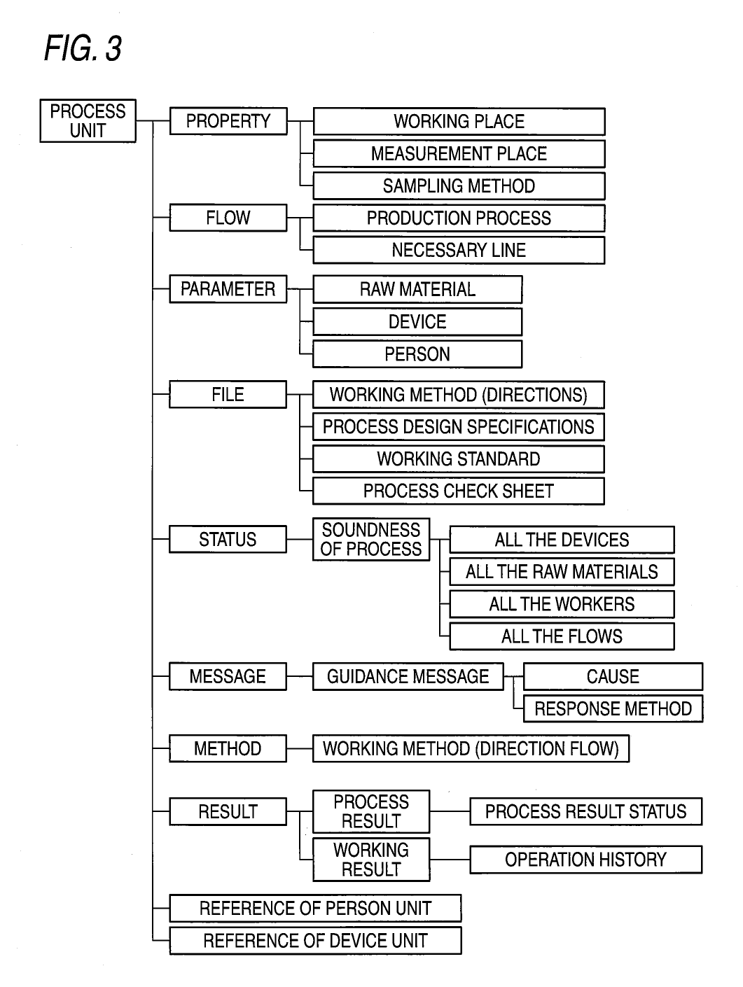

FIG. 3 shows an example of “a process unit” as an imaginary unit. The process unit monitors the processes of producing a product, and is a collection of information that collates a relationship of each process and related data. In the example shown in FIG. 3, data relating to processes are classified and stored into “properties” showing attributes of processes and “flow” showing the data relating to the flow of the production or the like. Furthermore, as a unit that is referable by a development from a display screen, a person unit and a device unit are designated.

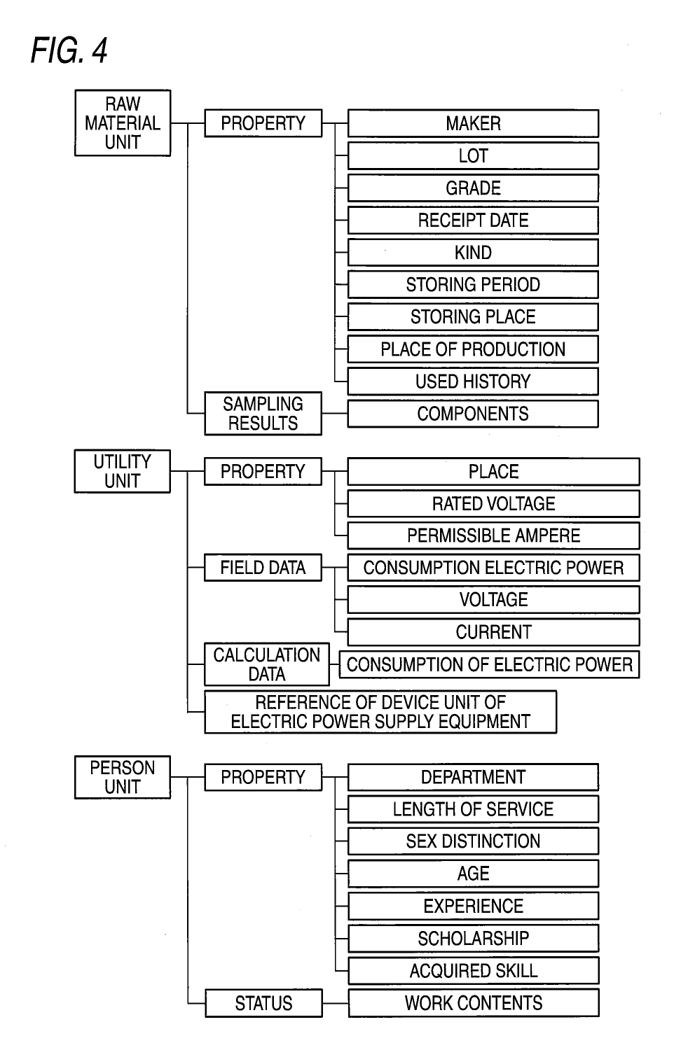

“A raw material unit” shown in FIG. 4 is an imaginary unit that monitors raw materials for making products and collates data relating to raw materials.

“A utility unit” shown in FIG. 4 is an imaginary unit that monitors utilities required for the production in plants and collates data such as the amounts used at every building.

“A person unit” shown in FIG. 4 is an imaginary unit that monitors a person engaged in the plant and collates data relating to the person.

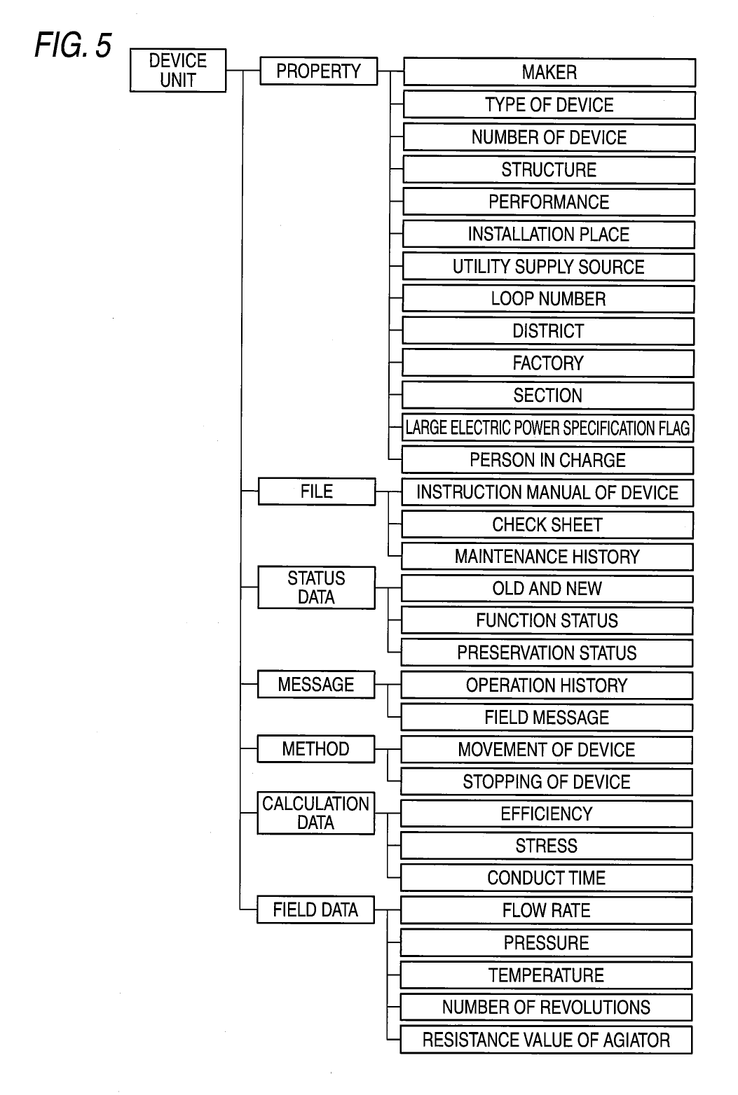

“A device unit” shown in FIG. 5 is an imaginary unit that monitors a device of the plant and collates data relating to the device.

In addition, it is possible to write “a task unit” which monitors works of a person engaged in a plant and collates data relating to working contents, “an environmental unit” which monitors a natural environment around a plant and collates data such as the weather and season, “a trouble unit” which monitors claims from clients after products are released and collates data such as causes and responses on a claim by claim basis, and an “a analysis unit” which monitors a process of pursuing causes of the claims and collates data such as analysis orders and a graph used.

This kind of imaginary unit can be written by a user from an arbitrary point of view via the definition receiving section 51 (FIG. 1B) of the terminal device 5, and an arbitrary data can be stored in the unit. The written imaginary unit is preserved in the preservation section 56 (FIG. 1B).

When a new imaginary unit is written, a user calls the previously written imaginary unit on the screen of the display 7, and designates and combines the data stored in the imaginary unit, thereby being capable of writing a new imaginary unit.

When the imaginary unit is called, arbitrary data included in the unit is used as a search key, and the unit can be searched by the searching section 53. For example, by using product names, lots, shipments, statuses of products or the like included in the properties of a product unit (FIG. 2) as search keys, the products units are searched, so that a necessary product unit can be extracted. Furthermore, when a process unit (FIG. 3) is called, by using data included in a property, a parameter and a status of a process unit as search keys, a necessary process unit can be extracted.

As described above, since an arbitrary element other than a time stamp in the time series data can be used as a search key, access to necessary information can be made to be greatly efficient.

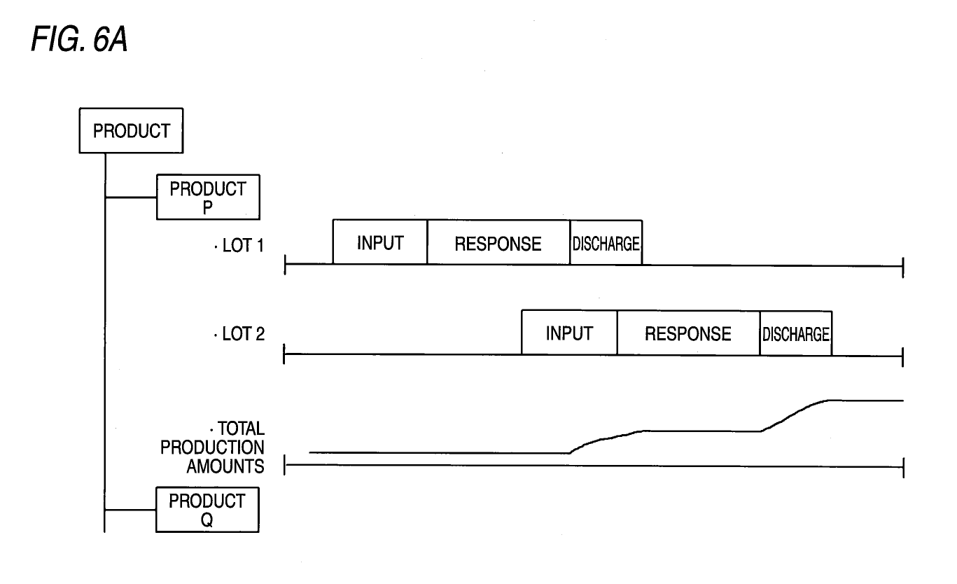

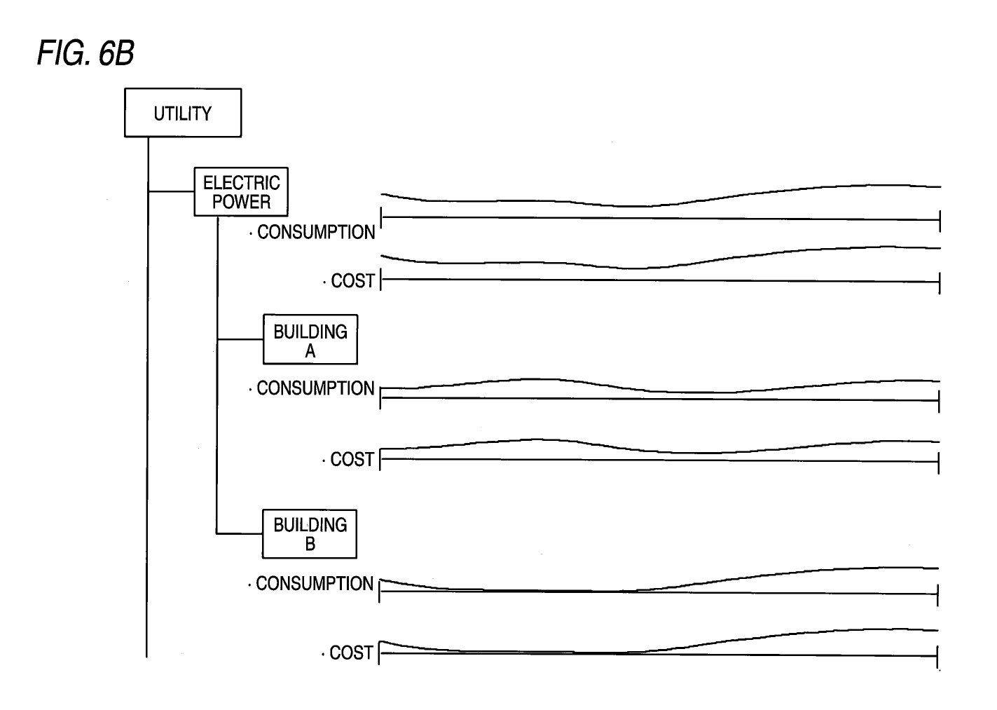

FIGS. 6 to 8 are diagrams that show an example of a corresponding relationship between each time series data (a part thereof) stored in an imaginary unit and the display configurations of each data. The data, which has been stored in the selected imaginary unit, is graphically displayed on the screen of the display 7 by means of the suggestion section 52.

For example, FIG. 6A shows a unit that stores a time series data group relating to a product, and for each product (a product P and a product Q or the like), processes at every manufacturing lot and the entire production amount of products are included in the unit. The plurality of the time series data can be arranged and graphically displayed on the screen of the display 7, and in this case, the time axis can be arranged in an arrayed state along the time stamp of each time series data.

Furthermore, FIG. 6B shows a unit that stores a time series data group relating to a utility, and energy kinds, consumption amounts of energies at every building, and costs or the like are included in the unit. Similarly, in this case, the plurality of the time series data can also be graphically displayed on the screen of the display 7 in such a manner that the time axis is adjusted along the time stamp.

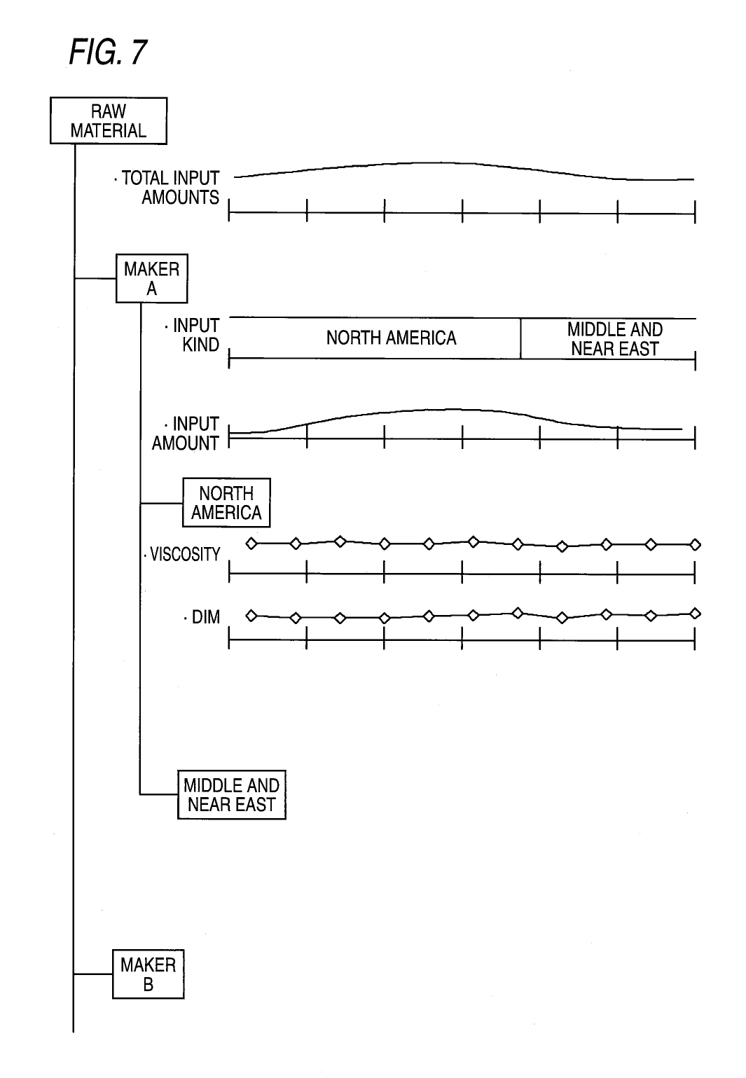

FIG. 7 shows a unit that stores a time series data group relating to a raw material to be input, and for each raw material maker and kind of raw material, an input amount and an inspection result of quality and the like are included in the unit. Similarly, in this case, the plurality of the time series data can also be graphically displayed on the screen of the display 7 in such a manner that the time axis is adjusted along the time stamp.

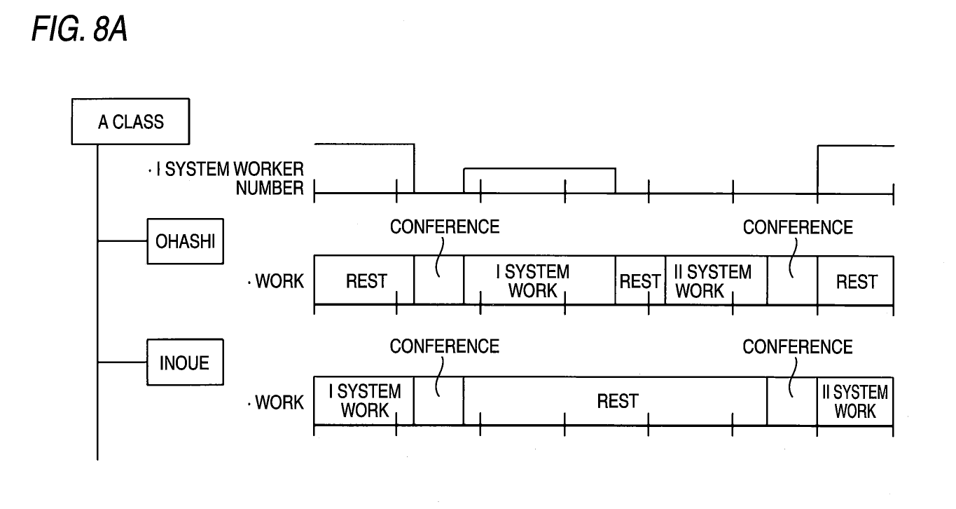

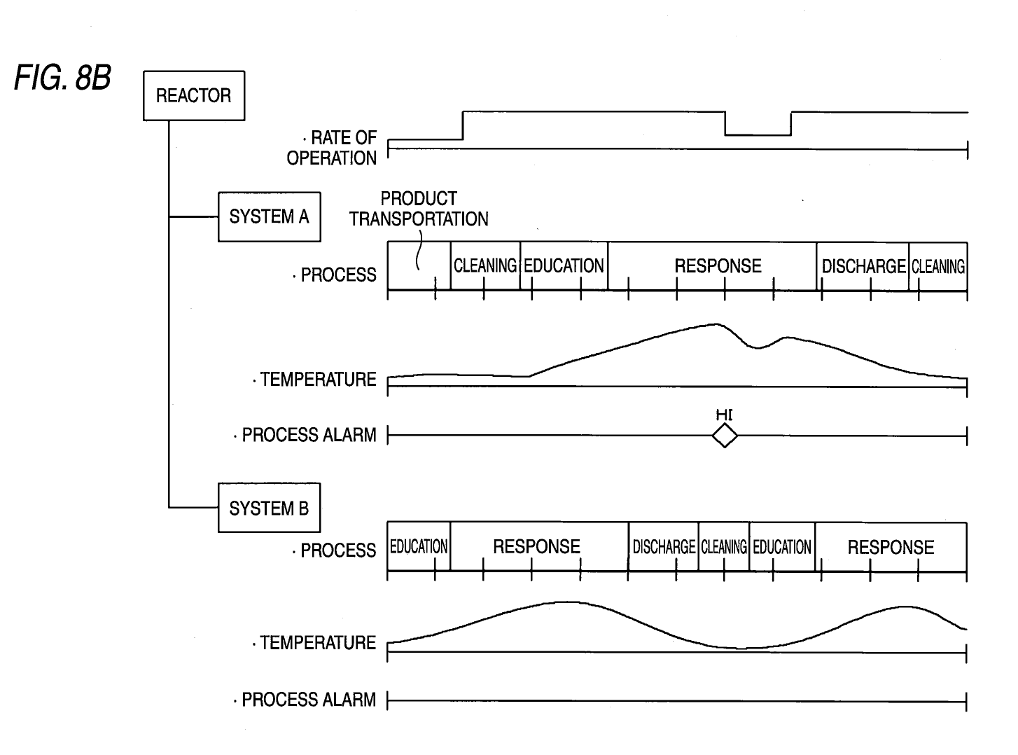

FIG. 8A shows a unit that stores a time series data group relating to a person, and a personal schedule and the total number of persons relating to each work or the like are included in the unit. Similarly, in this case, the plurality of the time series data can also be graphically displayed on the screen of the display 7 in such a manner that the time axis is adjusted along the time stamp.

FIG. 8B shows a unit that stores a time series data group relating to a device (a reactor), and for each system of the reactor, a process and a process data or the like are included in the unit. Similarly, in this case, the plurality of the time series data can also be graphically displayed on the screen of the display 7 in such a manner that the time axis is adjusted along the time stamp.

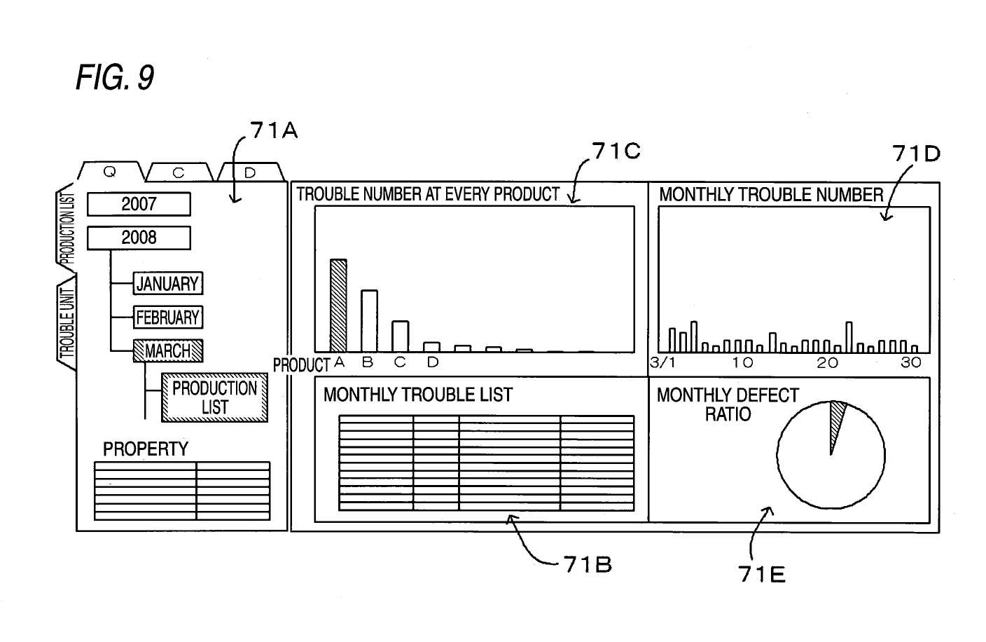

FIGS. 9 to 11 show diagrams of examples of display screens of the display 7.

FIG. 9 shows an analysis screen when a trouble arises in a product. Herein, “a product list” is developed and displayed in an area 71A, so that a production date is designated. The production date included in a product unit (FIG. 2) is searched by using the designated production date as a search key, so that the number of trouble occurrences (the number of times in which a status of a product unit indicates a trouble) can be extracted.

In this way, the user can provide the imaginary unit with a stratification structure via the definition receiving section 51 (FIG. 1B). In the area 71A, if a screen display is performed based on a given stratification structure and a specific unit is selected (clicked), a unit group of one lower level is developed and displayed. The developed and displayed unit is selected (for example, double-clicked), so that it can be developed to the display screen of the data stored in the unit. The other units described later are identical thereto.

The extraction results are displayed as a monthly trouble list in an area 71B. Furthermore, in an area 71C, the number of the troubles with every product (a product A, a product B, included in the monthly trouble list are graphically displayed. In an area 71D, by searching a production date of a trouble lot, the numbers of troubles (the number of lots) for each day for a month are graphically displayed. In addition, a result in which the numbers of troubles (the number of lots) for a month are divided by the number of the whole lots is graphically displayed as a monthly defective proportion in an area 71E.

The display configuration of this data can be set by an operation of a user who mediates the display screen of the display 7. Furthermore, this data group and the display configuration are registered as an imaginary unit named as “trouble 001”, for example, and can be preserved in the preservation section 56 (FIG. 1B). The trouble unit preserved in the preservation section 56 can be called on the screen of the display 7 according to an operation of a user who always mediates the terminal device 5, and the display configuration is reproduced.

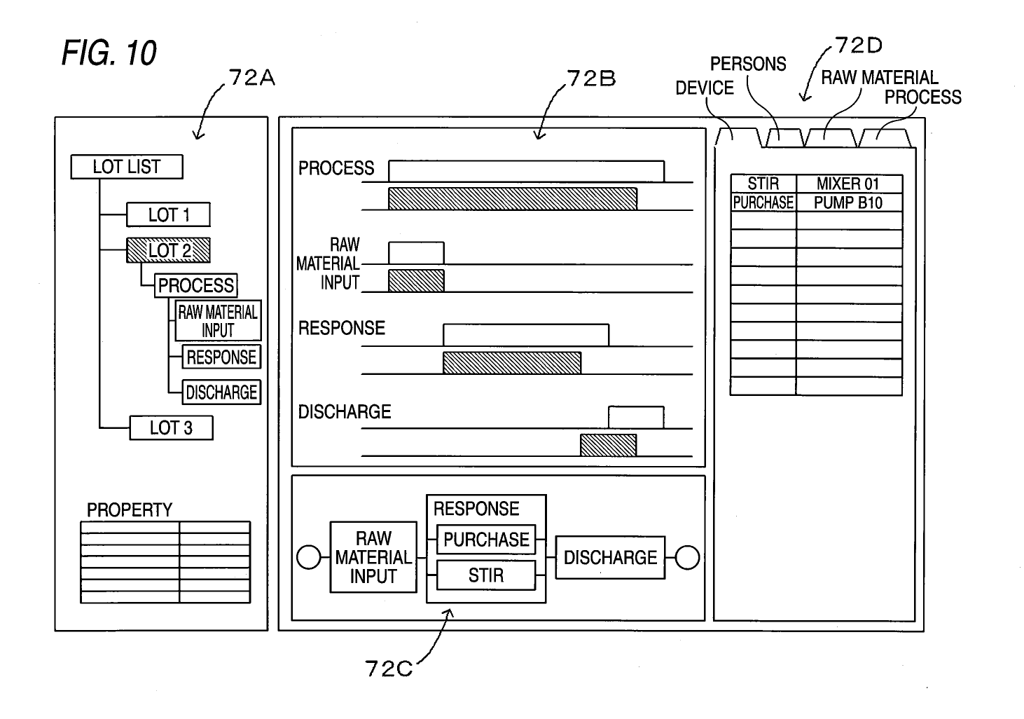

FIG. 10 shows an analysis screen of a batch process. Herein, a “lot list” is developed and displayed in an area 72A, and a specific lot (“lot 2”) is designated. The process unit (FIG. 3) is searched by using the designated lot as a search key, so that the time series data of the process for each lot can be obtained.

This time series data is graphically displayed in an area 72B. In addition, the user designates an ideal batch (golden batch) among the data stored in the server 4 (FIG. 1A) as historical data and can obtain the time series data of this process. In the example of FIG. 10, the time series data of the process relating to the lot and the golden batch are all displayed in such a manner that the time axes are adjusted. In the example of FIG. 10, both time axis is adjusted on the basis of the start of the process, and accordingly, by arranging each of the overall process (“process”), a raw material introduction process (“raw material introduction”), and a reaction process (“reaction”) and a taking out process (“discharge”), the required times of each process or the like can be compared.

In an area 72C, “a production process” is obtained from the “flow” of the searched process unit and is displayed.

A reference unit is displayed in an area 72D. A user can designate the reference unit via the definition receiving section 51 (FIG. 1B). The reference unit is designated on the screen so that the unit can be called on the screen of the display 7 from the preservation section 56 (FIG. 1B).

The data group and the display configuration contained in the analysis screen in FIG. 10 written by the user are, for example, registered as an imaginary unit named as “an analysis 001 order” and can be preserved in the preservation section 56. The analysis unit preserved in the preservation section 56 can be called on the screen of the display 7 according to the operation of the user who always mediates the terminal device 5, and the display configuration is reproduced. By calling this screen during operation of the plant, it is possible to easily obtain a suitable operation order or the like. In addition, when the operation order and the cause of the trouble or the like are investigated afterward, it is possible to simply obtain the necessary information.

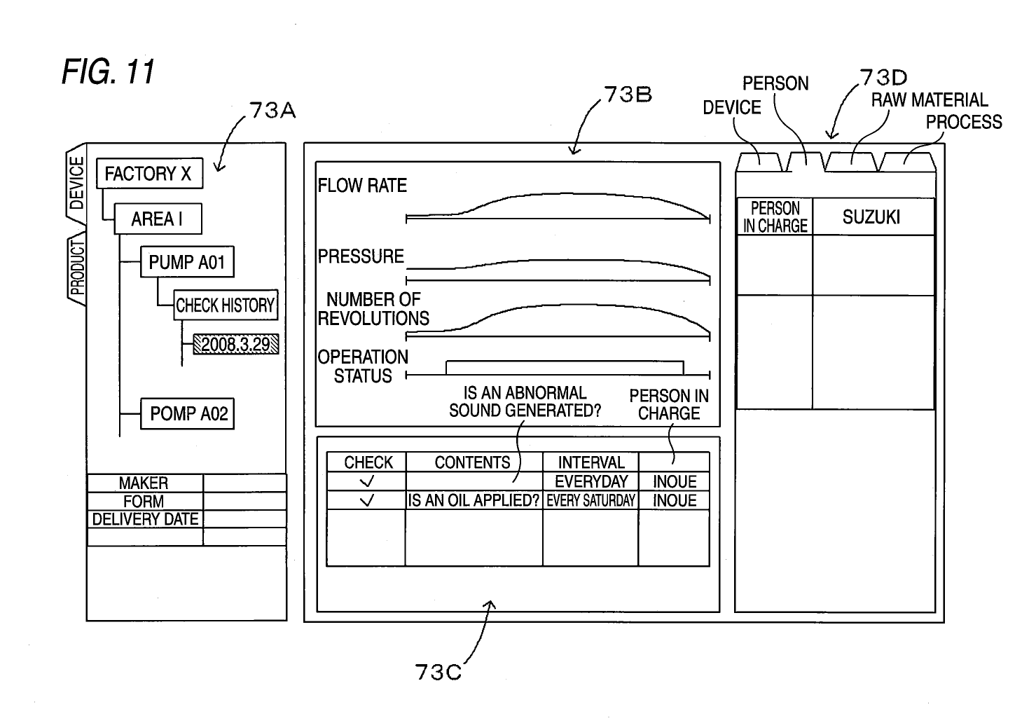

FIG. 11 shows a display screen indicating the detailed information of the device. Herein, a list of the device is developed and displayed in an area 73A to designate an inspection history a specific device (“pump A01”). The device unit (FIG. 5) is searched by using the designated device as the search key, so that field data (FIG. 5) at the time of inspection for each device can be obtained.

The obtained field data (time series data) is graphically displayed in a state in which time axes are arranged relative to each other in an area 73B.

Furthermore, “a check sheet” is obtained from a “file” of the searched device unit and is displayed in an area 73C.

The reference unit is displayed in an area 73D. The reference unit can be designated by the user. When the reference unit is designated on the screen, the unit is called on the screen of the display 7 from the preservation section 56 (FIG. 1B).

The data group and the display configuration included in the screen of FIG. 11 written by the user can be preserved as an imaginary unit in the preservation section 56. The unit preserved in the preservation section 56 can be called on the screen of the display 7 according to the operation of the user who always mediates the terminal device 5, and the display configuration is reproduced.

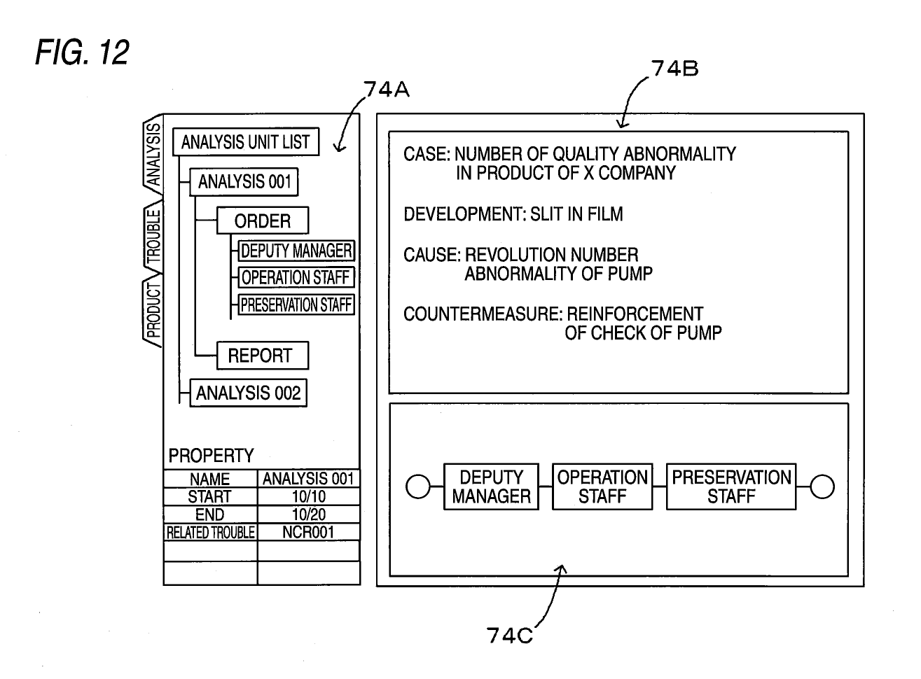

FIG. 12 shows a display screen of report information about a trouble. In the example of FIG. 12, the list of the analysis unit in an area 74A is developed and displayed and a “report” of a specific analysis unit is selected, so that the report result (file image) of the analysis is displayed in an area 74B. Furthermore, a flow of the analysis is displayed in an area 74C.

The data group and the display configuration, which has been written by the user and included in the screen of FIG. 12, can be preserved, for example, as an imaginary unit called as “analysis 001 report” in the preservation section 56. The unit preserved in the preservation section 56 can be called on the screen of the display 7 according to the operation of the user who always mediates the terminal device 5, and the display configuration is reproduced.

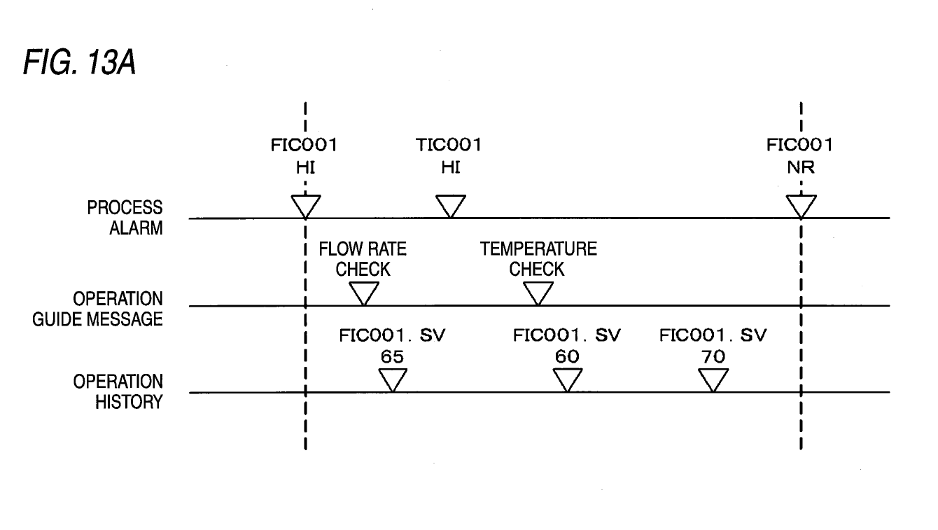

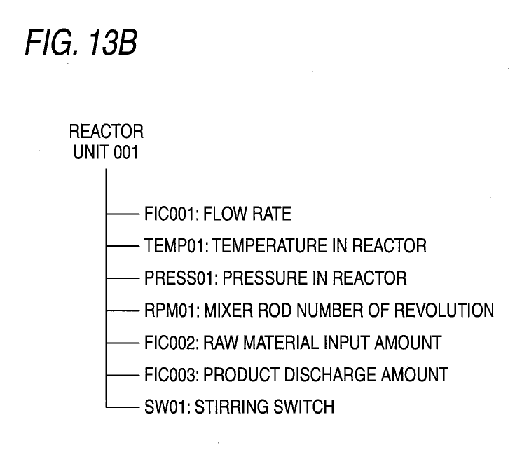

Hereinafter, with reference to FIGS. 13 to 15, there is described one method of using an imaginary unit for operative support at the time of occurrence of the alarm.

FIG. 13A shows one example of an event (time series data) constituting a past case of a response to an alarm. As shown in FIG. 13A, histories of events such as a history of a process alarm relating to the response to the alarm, a reporting history of an operation guide message, and an operation history are suitably associated. The association of the events to be used in the past cases can be arbitrarily set by the user. The past cases are obtained by searching the process unit. For example, “soundness of a process” (FIG. 3) in “status” is searched as the search key, so that the corresponding lot can be extracted and the histories of the events are obtainable.

Furthermore, FIG. 13B shows a field data (time series data) included in the device unit (reactor unit). By combining the field data relating to the response to the alarm with the event, the past cases of the response to the alarm are written. The corresponding field data can be obtained by specifying “device” (FIG. 3) in the device (“parameter”) used in the lot constituting the past case.

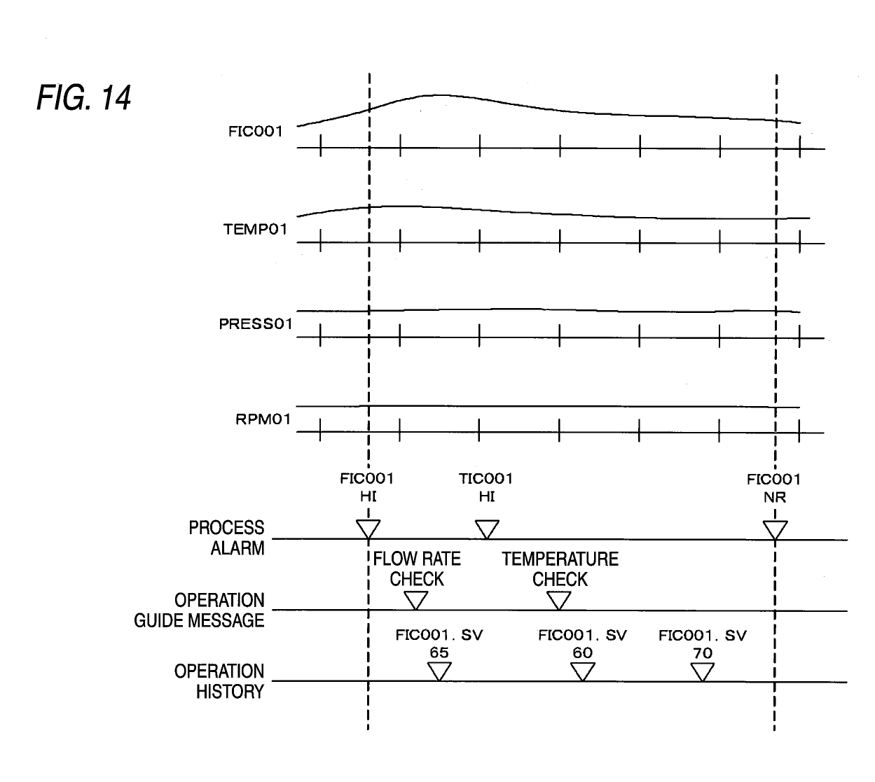

FIG. 14 shows a graphical display example of the written past cases. In the example of FIG. 14, based on each time stamp, the field data relating to the response to the alarm and the event are arranged and graphically displayed in a state in which the time axis is arrayed on the screen of the display 7.

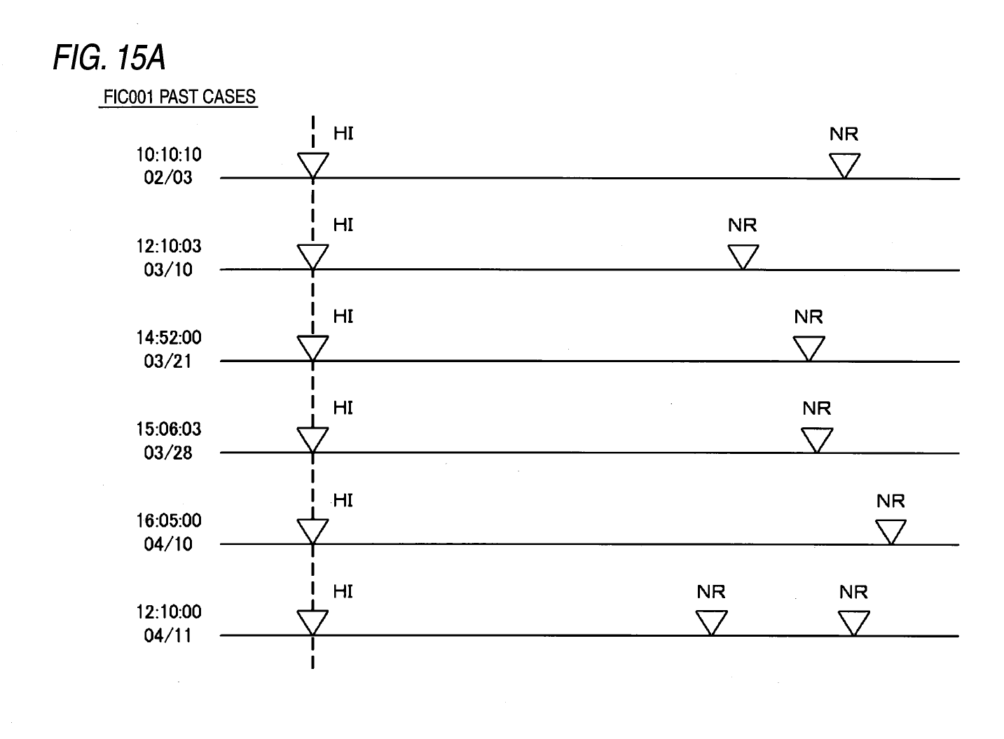

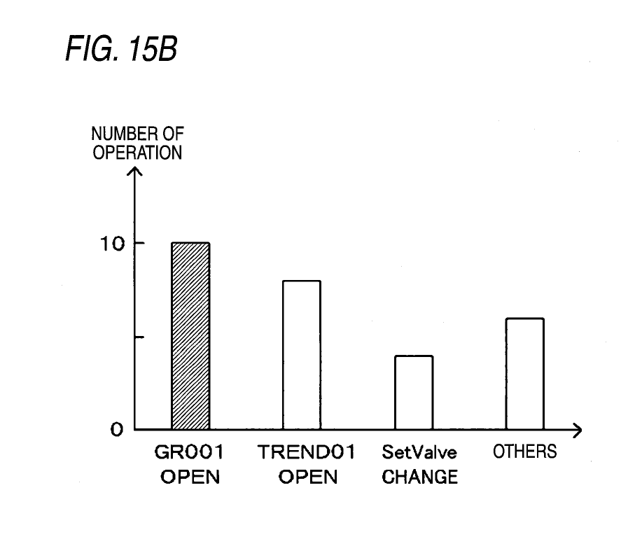

FIG. 15A shows an example in which timings of the events in a plurality of the past cases are graphically displayed. In this example, each display position is regulated so that the occurrence time points (“HI” in FIG. 15A) of the alarm in each of the past cases are united on the screen of the display 7, whereby there is obtained a display configuration in which times from the occurrence time point of the alarm to a recovery time point (“NR” in FIG. 15A) can be compared in an instant. The present plant situation in which the alarm occurs can be displayed so as to be arranged in parallel to the past cases in such a manner that the time axis is arrayed.

FIG. 15B shows an example of a display screen that displays the number distribution of operation contents to be adopted later after occurrence of the alarm. Each operational number is extracted by searching the past cases and is reflected on the display screen. Thus, the working staff can grasp the operation contents to be executed later.

The data and the display configuration constituting the screen (FIGS. 13 to 15) written by the user can be registered as an imaginary unit and are preserved in the preservation section 56 (FIG. 1B).

When the alarm arises, the working staff searches the imaginary unit of the preservation section 56 under the search condition corresponding to the present alarm situation, so that the past cases corresponding to the present alarm situation can be called on the screen of the display 7, whereby it is possible to obtain a suitable response method to the alarm. In addition, when the working staff executes a certain operation after the occurrence of the alarm, the past cases are restricted by researching the past cases on the basis of the operation contents, so that the usefulness of the information displayed on the screen of the display 7 can be improved. For example, by repeating the research, a distribution (FIG. 15B) of the operation number for the next operation is displayed on the screen in a real time. Thus, the working staff can grasp the operation contents to be newly executed.

As described above, by accumulating a method of response to the alarm and presenting the method at the time of necessity, it is possible to facilitate the quick decision-making of the working staff. In addition, by storing the necessary data group as a unit at the time of occurrence of the alarm, it is possible to quickly display only the necessary data among the vast amount of data in a small order. Furthermore, since a real operation executed at the time of occurrence of the alarm and the results thereof are accumulated as past cases in order, the user continuously uses the system so that a special engineering work is not required and the reliability of the information required for the decision-making can be improved.

Even in the same alarm, the best response method may differ depending on the humidity and the weather at that time, the raw material producing area, the age of a device, and the line used and the like. In order to be able to respond to such cases, at the time of searching the past cases, the humidity and the weather, the operation condition and the raw material producing area, and the maintenance timing of a device and the like may be restricted and used as the condition. In this case, by restricting the data and the imaginary unit in which the information is made to correspond to the lot, the lot satisfying the condition can be extracted.

As a condition for restricting the past cases, a data with a layer structure can be used. By adjusting the condition to the layer structure, a characteristic of a vague data can be clarified.

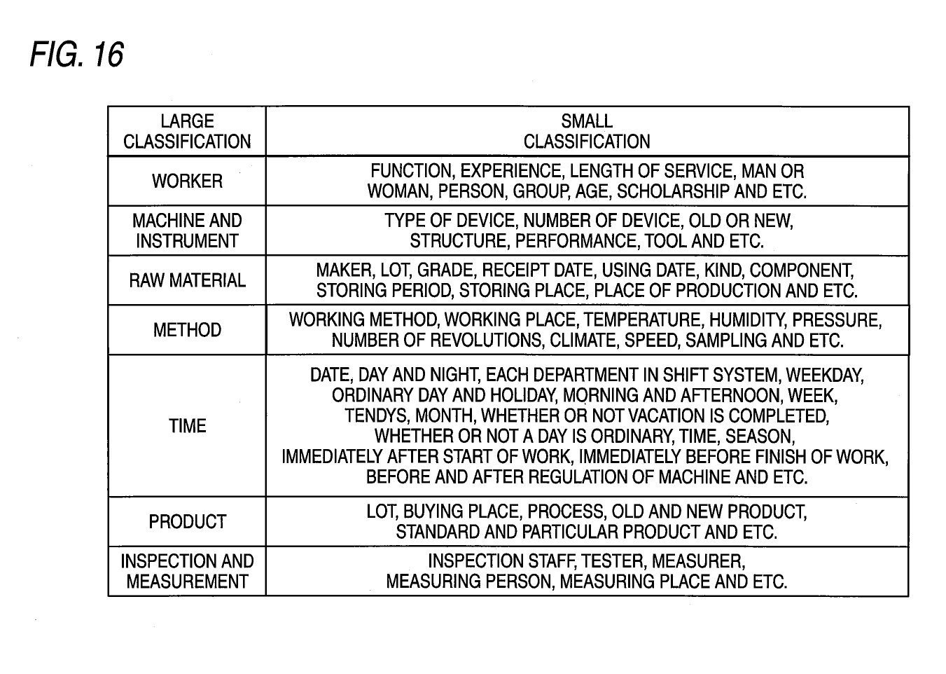

FIG. 16 shows an example in which the restriction condition is divided into two-staged layers of a large clarification and a small clarification.

As described above, according to the plant information managing device of the invention, by writing a collection of the data according to a purpose of an imaginary unit, unification of the data at a point of view of a user is made possible. As a result, easy access to the necessary data group is made possible, and accordingly, by preserving the imaginary unit, the collection of the data can also be used elsewhere.

Furthermore, the imaginary unit is searched by using the data stored in the imaginary unit as the search key, so that the past data is searched by using a thorough search of a product and the same operation condition as the keys, thereby resulting in easy access to the necessary data. For example, at the time of occurrence of a trouble or the like, it is also possible to rapidly refer to the past cases.

As described above, according to the plant information managing device and the plant information managing method of the invention, the definition of the unit as the collection of the data is received and accordingly, the data belonging to the predetermined unit which has been selected among the defined units is suggested, so that a data group relating to the plant can be effectively used.

An application range of the invention is not limited to the above-described embodiments. The invention is widely applicable to plant information managing devices and plant information managing methods which manage the data groups relating to the plant.

What is claimed is:

1. A plant information managing device for managing a data group relating to a plant, comprising:
a definition receiving section for receiving a definition of a unit as a collection of data, and
a suggestion section for suggesting the data belonging to a predetermined unit which has been selected among the units defined via the definition receiving section.

2. The plant information managing device as in claims 1, further comprising:
a searching section for searching the unit using the search key provided to the unit, wherein
the suggestion section suggests the data belonging to the unit searched by the searching section.

3. The plant information managing device as in claim 1, wherein
the suggestion section suggests the same kind of data belonging to a plurality of the units in a comparable manner.

4. The plant information managing device as in claim 3, wherein
the data is a time series data, and
the suggestion section displays the same kind of data in such a manner in which the time axis is arranged.

5. The plant information managing device as in claim 1, further comprising:
a preservation section for preserving the unit defined via the definition receiving section, wherein
the suggestion section suggests the data belonging to the unit preserved by the preserving section.

6. The plant information managing device as in claim 1, wherein
the unit defines the collection of the data relating to a particular product.

7. The plant information managing device as in claim 1, wherein
the unit defines the collection of the data relating to a particular process.

8. A plant information managing method of managing a data group relating to a plant, comprising:
receiving a definition of a unit as a collection of the data, and
suggesting the data belonging to a predetermined unit which has been selected among the units defined via the step of receiving the definition.
